(19) United States
(12) Patent Application Publication
(10) Pub. No.: US 2008/0228479 A1
(43) Pub. Date: Sep. 18, 2008

(54) Data transcription and management system and method

(75) Inventor: Manuel Prado, Santa Cruz, CA (US)

Correspondence Address: DERGOSITS & NOAH LLP, FOUR EMBARCADERO CENTER, SUITE 1450, SAN FRANCISCO, CA, 94111, US

(73) Assignee: VIVA Transcription Coporation, Santa Cruz, CA (US)

(21) Appl. No.: 11/900,441

(22) Filed: Sep. 11, 2007

Related U.S. Application Data
(63) Continuation-in-part of application No. 11/361,176, filed on Feb. 24, 2006.

(51) Int. Cl. G10L 15/26

(52) U.S. Cl. 704/235; 707/104.1; 704/E15.043; 707/E17.001

(57) ABSTRACT

What is disclosed is a data gathering, storage and management system, which includes a database in which data files are stored. The database includes a series of selected keywords each associated with one or more content files, the content files comprising advertisements, information, on-screen control buttons for performing a series of functions, and links for access to websites and other sources of information. The system accepts audio data files and identifies keywords that may be heard in the audio file. In one embodiment, the audio data file is transcribed and keywords are searched for in the transcribed text. The identified keywords from the audio data file are compared with the selected keywords, and at least one content file is selected for display for each retrieved keyword in the list which matches a selected keyword. The content file is displayed to the user so that the displayed content is relevant to the produced audio, which may be a recording of a conversation, a speech, or issued voice commands. What is disclosed is a method and system for providing relevant content to a user based upon speech.

### RELATED APPLICATION DATA

This continuation-in-part utility patent application claims priority under 35 U.S.C. §120 to nonprovisional patent application Ser. No. 11/361,176, filed on Feb. 24, 2006.

### TECHNICAL FIELD

The present invention relates generally to keyword-directed advertising systems and methods, and is specifically directed to systems and methods for utilizing audio and type-entry data to generate profile models to generate advertising and marketing revenue.

### BACKGROUND OF THE INVENTION

One type of data important to any business is customer information. The lifeblood of a business is its customer base. The more information a business gains about its customers, the more that business can tailor its products and marketing accordingly. Customer information can be used to implement successful advertising campaigns that can turn data into dollars.

A common method for generating customer information is through the use of focus groups. Focus groups can provide real-time customer reactions to products presented to them. Potential customers can be monitored, and the data used to form inferences about customer likes and dislikes. A shortcoming of the focus group is the pool of focus group participants. Focus group participants may not accurately represent the class of customers that a business is actively seeking. On the other hand, the use of focus groups reinforces the importance of real-time monitoring of customer behaviors.

In the television broadcasting context, companies such as Nielsen Media Research have historically conducted real-time monitoring of television viewers. This kind of data catalogs television audience interest that businesses can use to direct advertising campaigns. However, this type of data collection is limited to the entertainment context, which only represents a small portion of a typical consumer's interests.

A person's normal daily routine can involve a number of different interactions and exchanges that, if monitored, would present a better overview of that person's interests. Such interests could be marketed to and translated into sales revenue. Businesses, and the marketing and advertising consultants that serve businesses, can use such information to create and implement novel advertising and marketing strategies that directly serve a person's interests.

What is therefore needed is something and some way to generate real-time or near real-time information on a person while he or she is performing daily tasks, without being invasive or burdensome to the person. What is needed is a way to take this information and link it to relevant advertising that already exists, or use the information to create advertising for later service to the person. What is also needed is a system that can continue to deliver relevant content or advertising to the person during future encounters.

Another issue with current customer information-gathering methods is the emphasis on building full sets of demographic data. While helpful in the long-term, in some instances, it may be more beneficial to gather immediate or more focused customer information, and direct marketing efforts accordingly. The success of various viral marketing campaigns is a testament to the utility of quick, spontaneous but relevant advertising messages. What is needed is a way to collect information from customers quickly and use this information to efficiently deliver relevant marketing content in a relevant context.

In some cases, it is helpful to be able to generate relevant content to a potential customer based upon only a few bits of information disclosed by that potential customer. What is needed is a way to produce relevant content based upon only a few data points, while building up a more extensive profile of that customer, if desired.

### SUMMARY OF THE INVENTION

It is an object of the present invention to provide a new and improved data management system and method for generating customer information. This information may then be used for direct marketing or other purposes where customer information might be helpful. Rather than a passive method of providing content to whomever might be present to view the content, an object of the present invention is to provide relevant content based upon customer information gathered when the customer speaks.

According to one aspect of the present invention, an information gathering and management method is provided in which audio data is collected and stored. The data may be converted to a human-readable format (transcribed) or it may be kept in a computer readable format. In either case, the audio data may be read to look for at least one keyword. The audio data is then compared to a stored list to see whether at least one keyword matches a term on the stored list. The stored list may be associated with one or more content files, which may then be displayed to the user at the present or some future time. The display of the content file may form a portion of a document or other data file for the user, and may comprise advertisements, information, buttons for performing a series of functions, hyperlinks to other information or to another website, or commands or instructions for performing a task.

Another aspect of the present invention may permit a user to refer to the audio data, either as originally recorded, or after converted to a human-readable format, such as transcription to a text file. An embodiment of the present invention may allow for manipulation of the data file, such as editing, printing, appending to another data file or transferring to another party by way of electronic mail or facsimile. One or more users may grant or be given authority to perform operations on the data file, which may be stored and accessed through a network connected to a server computer, or locally stored on a local client computer.

According to another aspect of the present invention, a data storage and management system is provided that comprises a central processing unit having at least one database for storing a series of sets of data files, each associated with a list of selected keywords, each keyword associated with at least one content file for display, the central processing unit having a memory containing program instructions for scanning or receiving each data file at least once.

According to one embodiment of the present invention, the system may be internet based and may include a website permitting authorized users to link to the database for access to their stored audio data files. The system may include an advertising manager program for allowing authorized clients to bid on content files to be displayed to users based on keywords found in the audio data files. The system may order content files for display based on the bid value, with the content file corresponding to the highest bid being inserted first.

The data management system and method of this invention may allow businesses and services such as merchandise sales, law firms, publishing firms, health care providers, and the like, to store their audio data files in a central database, readily accessible by authorized users over the internet or other network. At the same time, the data files may be displayed to the user when retrieved with added value information added inline with selected keywords, so that the user can see convenient, up to date information on various topics raised in a human-readable form of the data file, as well as advertisements for ordering goods or services related to certain keywords, links to relevant websites, and convenient buttons for use in ordering supplies, services, or the like which may be needed in association with keywords in the audio data files.

In addition to storing content, the present invention may also permit content providers to bid on potential keywords. The present invention may provide a platform for an auction system that may permit content providers to submit bids to gain the opportunity to have their content associated with certain keywords. The content provider with the winning bid may have their content shown upon the occurrence or occurrences of the keyword. The auction system may provide a way for content providers to see the status of their bids, and may offer the opportunity to re-bid if a previous bid does not win.

As such, an aspect of the present invention may provide a system and method for hosting content provided by a third party, for delivery to a user upon present or future access or interaction with the present invention. An aspect of the present invention may provide a conduit for focused content delivery, which may result in more effective advertising and marketing campaigns for the content provider.

### BRIEF DESCRIPTION OF THE FIGURES

The present invention will be better understood from the following description of an exemplary embodiment of the invention, taken in conjunction with the accompanying drawings, in which like reference numerals refer to like parts, and in which:

FIG. 1 is a block diagram of the hardware components of a data management system according to an exemplary embodiment of the present invention;

FIG. 2 is a schematic flow diagram illustrating a data management process according to the exemplary embodiment of the invention;

FIG. 3 is a more detailed flow diagram of the steps for downloading and handling documents in the system;

FIG. 4 is a flow diagram illustrating the steps carried out by the insertion manager of FIG. 3;

FIG. 5 is a flow diagram illustrating the steps carried out by the transcription manager of FIG. 3;

FIG. 6 is a flow diagram illustrating the steps carried out by the advertising manager of FIG. 4;

FIG. 7 is an example of a document screen with information inserted according to the exemplary embodiment of the invention;

FIG. 8 illustrates a screen display providing during an auction carried out by the advertising manager of FIG. 6;

FIG. 9 is a screen display similar to FIG. 8 illustrating a subsequent step in the auction process; and

FIG. 10 is a screen display similar to FIG. 9 but illustrating a different outcome to the process.

### DETAILED DESCRIPTION OF THE INVENTION

What is disclosed is a method and system for gathering and managing audio data files, and associating additional content files with the audio data files based upon keywords gathered from the audio data files. For explanatory purposes, various specific embodiments may be discussed herein, but are merely exemplary and are not meant to be limiting in any way. Various other embodiments of the claimed invention not explicitly disclosed herein will fall within the metes and bounds of this disclosure without departing from the scope and spirit of the claimed invention.

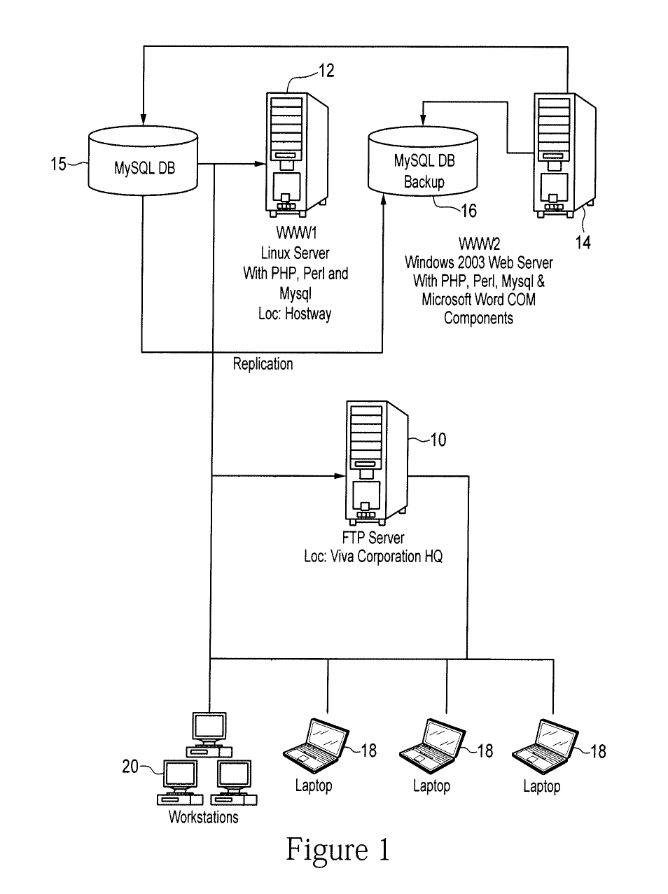

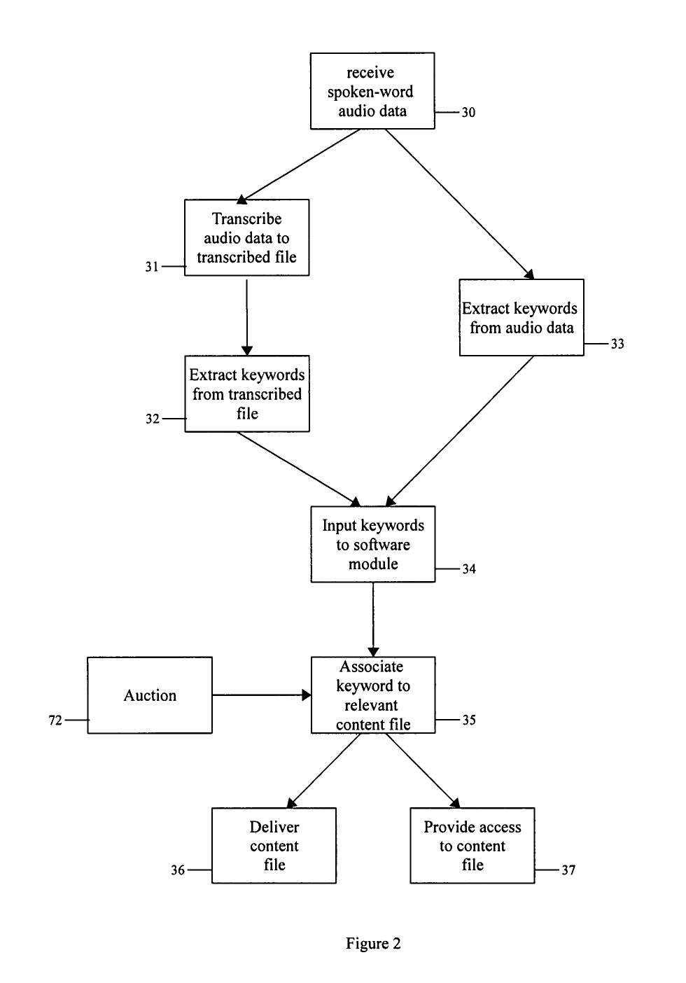

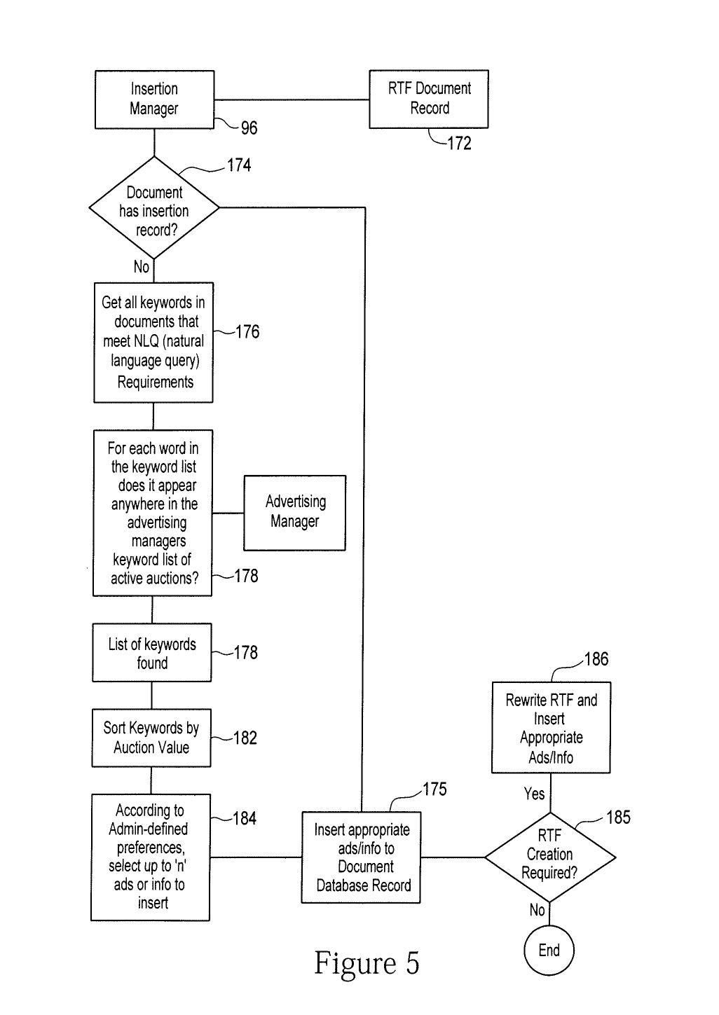

FIG. 1 illustrates the hardware components of a web or internet based data management system, according to an exemplary embodiment of the invention. FIGS. 2 to 10 illustrate the method steps carried out by the system, according to one embodiment of the claimed invention. Referring now FIG. 1, the basic components of the system may comprise a website or central processing system having an ftp (file transfer protocol) server 10 and two associated web servers 12 and 14, each having an associated memory storage or database 15 and 16, respectively. The website servers can be accessed via laptops 18 or client computers 20 over a network, or by local computers in a local network. Access to the central process system may also be wireless. One skilled in the art will recognize that the terms “network,” “computer network,” and “online” may be used interchangeably and do not imply a particular network embodiment or topography. In general, any type of network (e.g., LAN, WAN, SAN or internet) may be used to implement the online or computer networked embodiment of the present invention. The network may be maintained by a server, or the network may be serverless. Similarly, any type of protocol (e.g., HTTP, FTP, ICMP, UDP, WAP, SIP, H.323, NDMP, TCP/IP) may be used to communicate across the network. One will also appreciate that individuals accessing the system may be system administrators, customers, users, vendors, potential advertisers or other content providers.

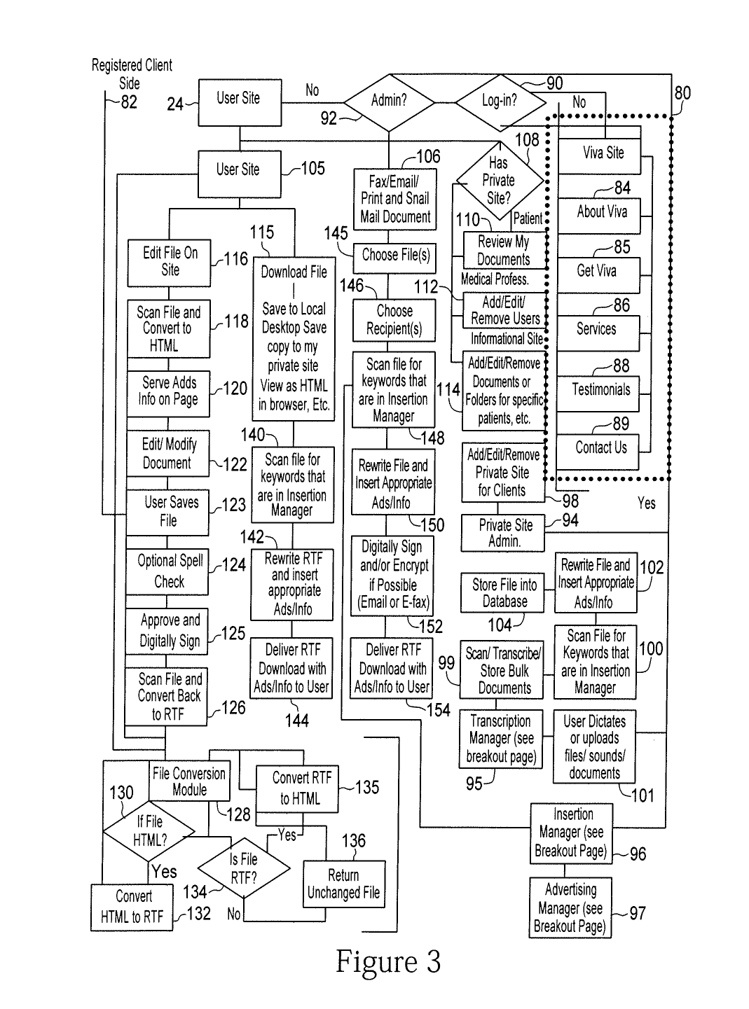

FIG. 2 is a basic overview of some of the method steps carried out in the system of FIG. 1, while FIG. 3 is a more detailed flow diagram illustrating the sequence of operations when an authorized user accesses the system. In one embodiment of the present invention, various method steps occur once the system receives an audio data file 30. The audio data file can originate from any instance where speech is uttered. In one embodiment of the present invention, an audio data file may originate from a conversation between two people. One will appreciate that such a conversation can occur in a real world situation, so long as the conversation is recorded and encoded into a computer-readable format. One will also appreciate that such a conversation can occur in a virtual context as well, such as when two avatars speak to one another in a virtual world. In another embodiment of the present invention, an audio data file is generated by an individual giving voice commands, such as during voice dialing, issuing vocal commands to an automobile computer while driving, issuing vocal commands to a home or office computer, or interacting with one of any voice-activated portals (“vortals”) such as that offered by TellMe Networks. One will appreciate that there are many situations where speech or other sound or audio data (including touchtone) can be encoded into a computer readable form for use with various aspects of the present invention.

As depicted in FIG. 2, in one embodiment of the present invention, the audio data file is then encoded into a format conducive for keyword searching. An embodiment envisions converting the audio data file into a human-readable format 31, typically referred to as transcribing, such that the present invention can search for keyword matches within the transcribed file. Such transcribing may be manual, where a live person listens to the audio data file and enters the spoken words into a text document. For purposes of this disclosure, the term document may refer to the human-readable transcribed version of an audio data file, but is not meant to limit its reference to only this type of version. Another embodiment of the present invention may include computer-automated transcription to a text document using speech recognition technology. Once transcribed or converted, keywords may be extracted 32 from the transcribed file. Yet another embodiment of the present invention permits a computer to read the audio data file without conversion, extract keywords from the audio data 33 directly, then looking for matches between words from a keyword list and words digitized in the audio data file.

Once keywords are extracted, in one embodiment these keywords are inputted to a software module 34 that performs the matching functions for the present invention. In embodiment, the software module identifies extracted keywords that have been associated to a certain content file 35. The association may be made through a typical pay-for-content arrangement, or may be associated by way of an auction 72. The particular content file can include many types of media.

One aspect of the present invention provides targeted information, instructions, advertisements or other relevant content to users and associated individuals in the form of pop-ups or other types of insertions or displays based on keywords found in the audio data files. In one embodiment of the present invention, the information may include relevant content directed to a particular keyword found in the audio data file or a transcribed version of the audio data file. For example, if a user is issuing voice commands to an automobile-based computer navigation system, such as inquiring about the location of nearby restaurants, an aspect of the present invention may record these commands. An aspect of the present invention may have a keyword list containing the name of certain restaurants. Particular keywords may be associated with specific content relevant to a restaurant that has paid for direct marketing should these particular keywords arise. In one embodiment, a relevant advertising or coupon code could be associated with a keyword and caused to appear in the display of the user's automobile-based computer navigation system. In this fashion, the present invention may operate as an advertising mechanism for a restaurant, providing relevant content when certain keywords are spoken in the car.

In another example, two avatars may be having a verbal conversation in the virtual world of Second Life. One user may mention the word “shoes.” An embodiment of the present invention monitoring this conversation may note that “shoes” is a keyword associated with the company Adidas, which has sponsored specific content for display in the Second Life world. An embodiment of the present invention may cause a display of Adidas-related content to appear before the users, either in a virtual billboard visible in the virtual world, or as part of the user interface that a Second Life participant uses to interact with the Second Life virtual world. The displayed content may be a passive display of advertising-type information, or may permit some level interactivity, such as a hyperlink to purchase Adidas products for real world use, or Adidas products for virtual world/avatar use.

In yet another example, a user may be utilizing a third-party service for the transcription of files, such as legal or medical files. A user may call a toll-free service to dictate over the phone, or dictate into his computer for upload to the service's website, or my dictate into a digital recorder and provide the digital recording to the service. In either context, an audio data file would be produced where certain keywords may be voiced. An embodiment of the present invention may extract these keywords from the dictation and present relevant content to the user based upon these keywords.

In yet a further embodiment, the content provided may not involve any sort of directed marketing, but may also comprise informational announcements, news or other displays of relevant content. An embodiment of the present invention may cause the content to appear immediately for the user, or the information may be stored for later display. Content delivery may be delayed pending the appearance of a sequence of keywords. For example, audio data from one day may contain the word “diet,” while audio data from the same user may contain the term “dinner.” An embodiment of the present invention may cause content directed to low-fat foods to be delivered to the user based upon the extended occurrence of this combination of keywords.

In another embodiment, information from a user's prior audio data files may be used to generate a library of content for delivery to the user. For example, a user may interact with the present invention on more than one occasion. In the medical transcription context, a physician or the physician's staff may access transcribed medical files over the phone or web. This access may be facilitated by using a single user identification code, name or number. If the physician provides cardiovascular care, and the present invention has confirmed the present of a number of keywords from prior transcribed files, then during a future interaction with the service, an embodiment of the present invention may deliver content marketing certain cardiovascular drugs. One will appreciate that the future content delivery may not be contemporaneous with the provision of spoken word audio data files, but may be the result of keywords gathered from previously provided spoken word audio data files. In one embodiment, content is delivered as announcements while the user is on hold on the telephone. One will appreciate that this embodiment may apply in other contexts outside of the medical environment, and that this example is merely illustrative and not limiting.

In another embodiment, the user may be provided with a link to the relevant content, or the content may be delivered directly to the user. Content may be provided in a visual format, such as displayed on a screen or printed onto paper or some other surface. Content may also be provided in an audio format, such as over the telephone. One skilled in the relevant art will appreciate that there are many ways to deliver relevant content based upon speech. Keywords found in the user's audio data files may also be stored and used to build demographic information about the user. One skilled in the relevant art will appreciate that there are many uses for delivering relevant content based upon speech.

Once the software module has identified content file relevant to a keyword, aspects of the present invention may either deliver the content file 36 or provide access to the content file 37. In one embodiment of the present invention, the submitter of the audio data receives or accesses the content file. In another embodiment of the present invention, other users of the audio data receive or access the content file. For example, in the medical transcription context, while a physician may have originally submitted an audio file of a patient history to the system, but other medical professionals working on that particular patient may use the audio file or a transcribed version of that audio file, and may therefore be considered good candidates for receiving or accessing relevant content files. The present invention contemplates many such instances.

One skilled in the relevant art will also appreciate that the term “keyword” may not necessarily represent a word found in the dictionary. The present invention may be adapted to search audio data files for any speech string or spoken sound, including codes. For example, content may be associated with a user ID entered over the telephone as spoken data or as touchtone entry. An embodiment of the present invention may be able to associate and deliver content to a user based upon this type of entry, using demographic information from the user's profile, such as zip code, or using information from prior interactions with the user, such as previously stored audio data files. Similarly, a keyword identified in the audio data file may not exactly match one in the stored keyword list. An embodiment of the present invention may provide the flexibility for variations on the keywords, including acronyms, synonyms, homonyms, or other ontologies. An embodiment of the present invention may also prevent content from being provided based upon a particular keyword combination or match. This embodiment may provide a content provider with the ability to customize content delivery in a more granulated manner.

One embodiment of the present invention may permit users to manage and manipulate transcribed versions of their audio data files. In one embodiment, the transcribed versions are in a human-readable form, such as Rich Text Format (RTF). Transcription may be handled by a specific computer instruction or system component called a transcription manager. FIGS. 3 to 6 are flow diagrams illustrating software aspects of the present invention to manage and augment transcribed files. As indicated in FIG. 3, in one embodiment the data management system and method website may have a public or internet portion 80 accessible to all users, and a private or extranet portion 82 accessible only to authorized users and website administrators. Within the private portion may be private sites associated with each authorized user in which all their records are stored. For example, if the system is designed for health care practitioners, it may contain patient records, billing records, and the like. Within each private site may be sub-sites which may have limited information accessible to individual patients, such as their own records or educational or treatment information. An aspect of the present invention may therefore permit not only the audio data file creators to access their transcribed files, but associated users may be granted access. The public portion 80 may have information about the company providing the service 84, click-on buttons to sign up for the service 85, a description of the services provided by the site 86, testimonials 88, and a contact page 89. One will appreciate that many additional options are available that will augment the service 84 without departing from the spirit of the invention.

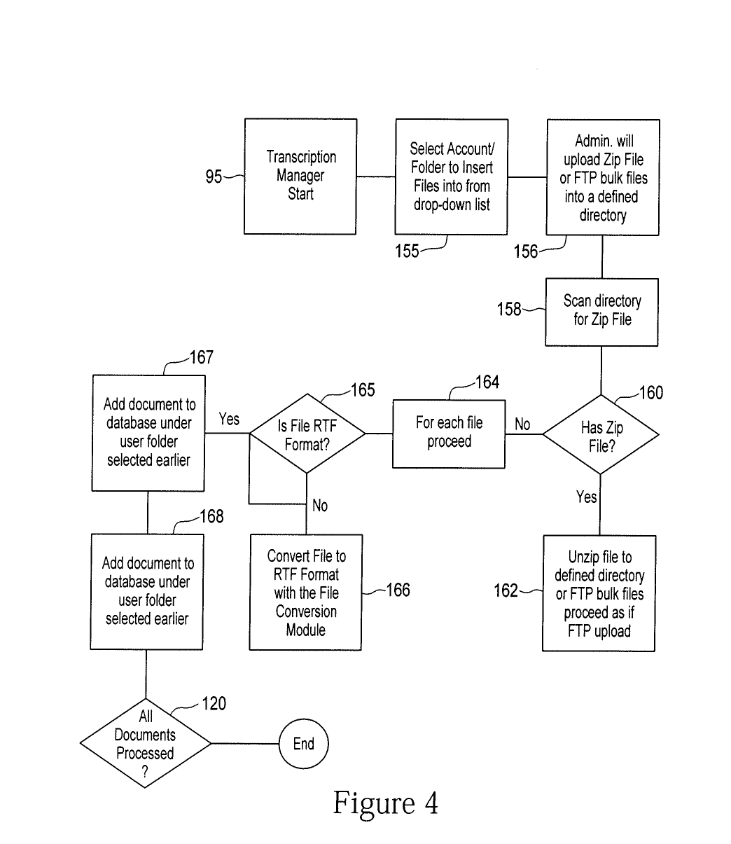

According to one embodiment of the present invention, when a user logs on to the website (step 90), they may be directed to the public portion if they do not have a user id and password. If they are a system administrator (step 92), they may access private site administration 94, transcription manager 95, or insertion manager 96 which may include the advertising manager 97. One will appreciate that while FIG. 3 refers to the advertising manager 97 as the system component that handles the association and insertion of marketing and advertising information, the advertising manager 97 may also insert content other than advertising. These three system components are illustrated in more detail in FIGS. 4 to 6.

Private site administration 94 may allows the administrator to add, edit or remove private sites for clients 98. The transcription manager 95 may control scanning, transcribing, and storing of audio data files dictated or uploaded by the user (101), scanning, transcribing and storing of bulk data files 99, scanning files for keywords that are in insertion manager 100, rewriting files and inserting advertisements and other targeted information 102, and storing files into database 104. According to one embodiment of the present invention, when a site is initially set up by a doctor's office, hospital, or the like, the new user may provide all of the paper medical records, which may extend back several years. This step is similar in other contexts beyond the medical record transcription realm. In step 99, an administrator may scan all the paper records into the system and store them in the private site for that client. An administrator may also control transcription and storage of new documents in step 99. Audio data files uploaded by the user may be transcribed by a transcriptionist or by a computer using voice recognition technology. The transcribed document may then be handled in the same way as scanned or otherwise downloaded documents for storage, according to one embodiment.

If the user is not an administrator, then according to one embodiment he may be directed to an authorized user site 24, where they can review files 105, fax, email, print and snail mail documents (step 106), or perform administrative functions on the private site (step 108). The private site may have the option for a patient to review their documents (step 110). The medical professional can also review documents (110), add, edit or remove authorized users (112), and add, edit or remove documents or folders for specific patients (114), for example when a new patient enters the practice. Similarly, in other industry contexts, a user may review the transcribed versions of their audio data files (step 110); add, edit or remove authorized users (112); and add, edit or remove transcribed audio data files to restrict access by other users (114).

When the authorized user selects the option to review transcribed audio data files (step 105), he may either download the file (step 115) or edit the file on the web browser (step 116). In one embodiment, audio data files can be uploaded using a telephonic interface, such as calling a toll free telephone number and recording a message, or uploading a file from the user's computer. If the user wishes to edit an existing, transcribed, scanned, or uploaded file, then according to one embodiment, the file may first be loaded from the database and converted from RTF into HTML format for display by the file conversion manager (step 118). All existing, saved documents or files in a user's private site may have already been scanned and may have content, advertisements or information associated with various keywords in the document. This information may not be saved with the document or file. In one embodiment, the transcribed audio data file is tagged with the name or reference to the content, advertisement or information. In one embodiment, when the document is retrieved by the user, the document is scanned to see if it is already tagged for insertion of content, and content is again served with the transcribed audio data file (step 120) and to appear inline with the HTML page for display when the user views or edits the file. The user may then edit or modify the transcribed audio data file (step 122), saves it (step 123), may perform an optional spell check (step 124), and/or then approves and digitally signs their approval of the transcribed audio data file as final and correct (step 125), whereupon the file is scanned and converted back to RTF (step 126) and saved to the system. An embodiment of a file conversion module 128 for carrying out the file conversion steps is illustrated at the lower left hand corner of FIG. 3, and involves steps of determining whether a file is HTML (130), converting the HTML to RTF (132), determining if the file is RTF (134), and converting RTF to HTML (135), or returning the unchanged file if it is already HTML (136). One will appreciate that the file conversion module 128 may convert an audio data file from one format to another without restriction to the type of format. Similarly, the file conversion module 128 may convert transcribed audio data files from one format to another without restriction to the type of format.

The user can also opt to download an audio data file or transcribed audio data file in step 115. This may involve saving the file to their local desktop, saving a copy to their private site, viewing the file as HTML in their browser, and the like. Whenever the user chooses this option, the file may be scanned to see if it has already been tagged for insertion of information. If so, the relevant content, including information or advertisements, may be inserted. If not, the file may be scanned for keywords that are in the insertion manager (step 140), and the file may be rewritten with the target advertisements and other information inserted into the file (step 142). The downloaded file with inserted content, advertisements and/or information is then delivered to the user (step 144).

In step 106, the user can fax, email, or print and standard mail a document, according to one embodiment of the present invention. This option enables users to fax or email transcribed or stored audio data files directly from the online application, simply by clicking a fax or mail button and filling in some fields. The user may also select an option of sending out the document by standard mail. The user may first choose the type of service (fax, email, or standard mail), selects the file or files he wishes to send (step 145), then chooses the recipients (146). This may include the names, addresses, fax numbers, email addresses or other contact information for the recipient. In one embodiment, the system then scans the selected file or files for keywords that are in the insertion manager 96, in step 148. The insertion manager may select content, advertisements or other information to be inserted into the transcribed audio data file according to keyword auctions and administrator preference, as discussed in more detail below, if the file is not already tagged for such insertions. The file may then be rewritten with the appropriate targeted advertisements and information inserted (step 150). In one embodiment, the user may digitally sign and/or encrypt the letter, email, or fax (step 152). The fax, email, letter or the like is then delivered to the recipients with targeted information inserted on the document (step 154). The content, advertisements and other information served on the fax, email, or printed letter may or may not be the same as what appears on the online document. When the user selects the standard mail option, the letter will be printed and mailed by the website service. In this case, additional advertisements may be sent within the actual envelope. One will appreciate that the insertion and/or display of content based on keywords found in the audio data file can take place at any time before and during display of the audio data file to the user. Once an audio data file has been scanned and keywords identified, the insertion manager can be activated to link up the found keywords with relevant content. One will appreciate that the present invention is flexible and can accommodate real time as well as delayed delivery of content without departing significantly from the spirit of the invention. One will also appreciate that the display of the inserted content may form part of the audio data file, or may be displayed alongside the audio data file, or may be delivered in a file format that may be the same or different from the audio data file format.

In one embodiment, the transcription manager 95 may be accessible by website administrators only, and is illustrated in more detail in FIG. 4. It is an automated administrative module which may use voice recognition and optical character recognition (OCR) technology to automatically scan, transcribe, and store new documents to be added to a user's site. One will appreciate that as new technology comes available to convert audio data files to readable text files, the present invention may incorporate that new technology without departing from this disclosure. In one embodiment of the present invention, the transcription manager 95 may work in concert with the insertion manager. As each audio data file is passed to the insertion manager before storage in the database, any relevant content, advertisements or information may be added, just as if the file were entered or uploaded manually by an authorized user. In one embodiment, the transcription manager 95 may bulk import documents into the data management system. One will appreciate that the transcription manager 95 may take a large collection of documents in any digital format, do OCR as required, and then use the insertion manager on each document to insert content, advertisements and/or information into the documents. Content may be inserted or included with the displayed file at any point after receiving the audio data file and identifying keywords from the audio data file.

In one embodiment of the present invention, using the transcription manager 95, a user may use a drop-down list to select a user account and folder into which the content files are to be inserted (step 155). Compressed zip files or FTP bulk files are then uploaded into a defined directory (step 156). The directory is then scanned for zip files (158). If a zip file is located (160), the file may be unzipped to a defined directory and uploaded (162). A series of steps may then be carried out for each file, starting at step 164. Any non-zipped files located at step 160 proceed directly to step 164. If the file is not in RTF format (step 165), it is converted to RTF (step 166). In step 167, the RTF document or converted RTF document is then added to the database under the user/folder selected in step 155. It is also sent to the insertion manager for insertion of targeted advertisements and information (step 168). Once all documents have been processed (169), the subroutine ends (170). One will appreciate that other file types may be substituted in place of the exemplary zip and RTF file formats disclosed herein without departing from the spirit of the present invention.

In one embodiment, files are sent to the insertion manager 96 for scanning and insertion of content at various points. The files may be sent by the transcription manager when new documents are being added to the system, whether by scanning, transcribing from audio files, or the like (see step 168 of FIG. 4). The files may be sent to the transcription manager for scanning when a file is downloaded by an authorized user for viewing or other purposes (step 140 of FIG. 3). In another embodiment, files are sent for scanning and content insertion when an authorized user wishes to fax, email or print and snail mail a document (step 148 of FIG. 3). One will appreciate that many variations of the steps are possible.

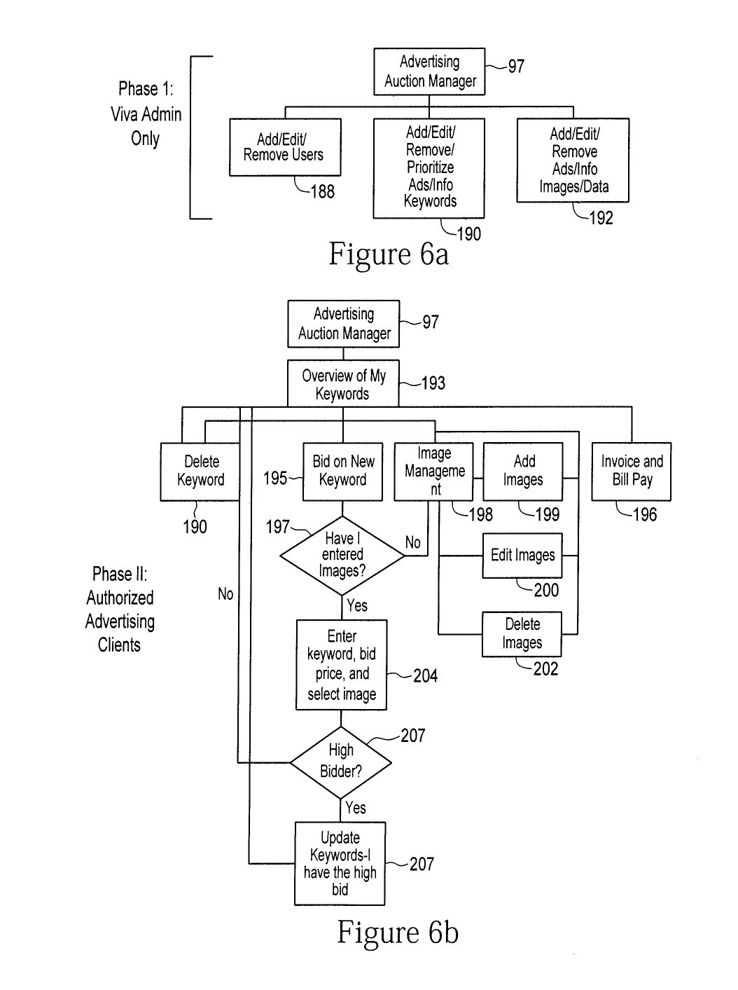

According to one aspect of the present invention, the insertion manager may use a list of saved keywords in order to select content, advertisements and/or relevant information for insertion into the displayed form of the audio data file. The list may include keywords selected by the system administrator, or the keywords may be based on active words in an auction or advertising manager 97, which is illustrated in more detail in FIG. 6. Transcribed audio data files in the form of RTF documents that require insertion of content (172) may be provided to the insertion manager, which may determine whether the document has an insertion record (step 174). If transcribed file has already been tagged with references to content for insertion, the appropriate content may be inserted into the file at step 175. If the transcribed file has no insertion record, the file may be scanned to locate all keywords in the document that meet NLQ (natural language query) requirements (step 176), or similar query language. Natural language query is a system that effectively reduces a document down to its essence by removing or ignoring words such as “a”, “the”, “it”, and the like, and stripping off plurality and other words which are not of interest, creating a list of keywords that may be of interest for matching purposes. One will appreciate that other query methods are available that can be used to scan an audio data file.

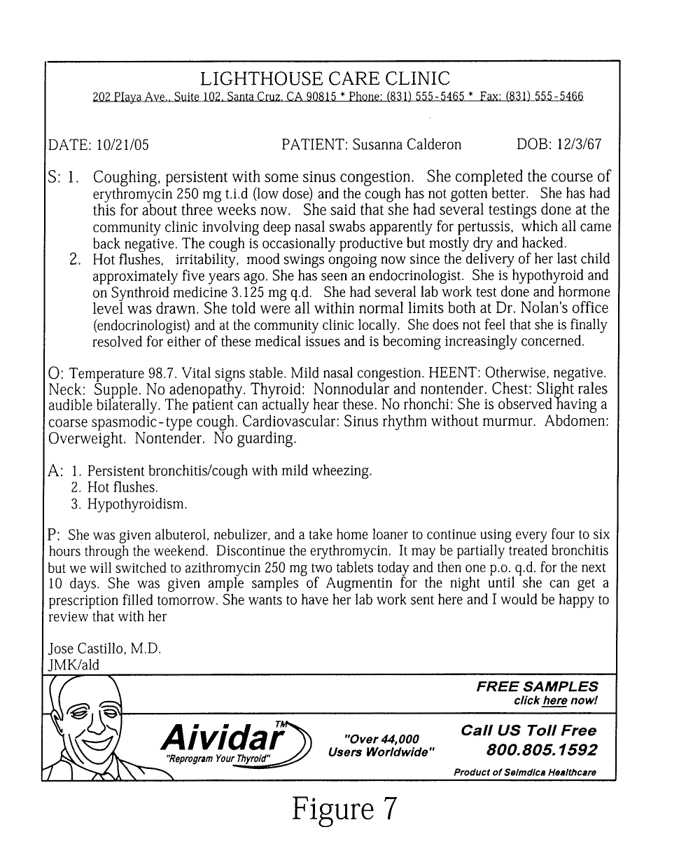

Once the distilled keyword list has been obtained from the document, which may be the audio data file or a transcribed audio data file, the list may be compared with active keywords in the advertising manager (step 178) as well as keywords associated with other types of information to be inserted, according to one embodiment of the present invention. A list may be made of the active keywords found in the document (step 180). These keywords may then be sorted by auction value (step 182), which permits content providers to bid for association of their content with specific keywords. According to administrator defined preferences, a number n of content, advertisements and information may be selected for display (step 184), and the content, advertisements and information selected are inserted into the document database record (step 175). If RTF creation is required (185), the document is rewritten as an RTF file and the advertisements and information are inserted (186). Similarly, the document may be rewritten in other formats with the content produced in a compatible format to enable seamless viewing. For example, the display and associated contend may be in Portable Document Format (PDF), a proprietary document format (such as DOC), or an open source document format (such as ODT or other xml variation). FIG. 7 illustrates an example of a document as it may appear on the screen after a advertising content has been inserted. The advertisement has a button which can be clicked on to find out more information about the product being advertised. Other embodiments of the present invention may provide for the content to be transmitted to the user for download or printing. One will appreciate that many content delivery options are available once the present invention has identified which content to deliver.

FIGS. 6a and 6b illustrate the advertising or auction manager subroutine in more detail. According to one embodiment, the advertising manager may be responsible for keeping track of keywords as well as their order of priority for use by the insertion manager. In FIG. 6a, keywords may be determined manually by a system administrator. In one embodiment, the administrator may add, edit or remove users (step 188), add, edit, remove and prioritize content, advertisements and other information based on keywords (step 190), and may add, edit or remove content, advertisements, images, information, and other data (step 192). According to one embodiment, this part of the program controls insertion of non-advertising information into a document. A large variety of different types of information may be added by the advertising manager, and the information may include some or all of the following listed types of information, as well as other types of information:
Targeted pop-up advertisements for medication, medical equipment, and the like;
Links to appropriate websites, books, or support groups based on a diagnosed condition;
Billing codes for certain procedures;
Pertinent information on patient drug allergies and other patient-specific medical or financial information based on the identification of the patient who is discussed in the file (this can be retrieved from the patient's medical history that is also stored on the user's private site);
Menus or order buttons for selecting and ordering medical tests, x-rays or the like and for electronically authorizing prescriptions with a pharmacy or drug distributor;
Links to pharmacies, drug representatives, medical supply companies and the like;
Links for calendaring prescription refills or follow up visits with a patient;
Links to detailed information on drugs or treatments a doctor may be ordering, such as side effects, how a medicine should be taken, drug interactions, what reactions to a drug or treatment are normal or otherwise, drug effectiveness, other health care providers experiences with the same drugs or treatments, and so on;
Access to an online medical glossary;
A button allowing a doctor to automatically print a prescription for a patient with all relevant information filled out;
Useful information for a patient and family members or caregivers for the doctor to print out, such as what side effects may occur and what to do in the event of such side effects, how much and how often medication should be taken, and how it should be taken, what to do if a dose is missed, when to report back to the health care provider, and the like;
A button for a doctor to click on to inform other physicians via email, voicemail, or fax of a treatment they are recommending for a patient they all have in common.

One will appreciate that while the above examples refer to use of the present invention in the medical transcription context, numerous other embodiments are possible using the present invention. The above examples are not intended to be limiting in any fashion.

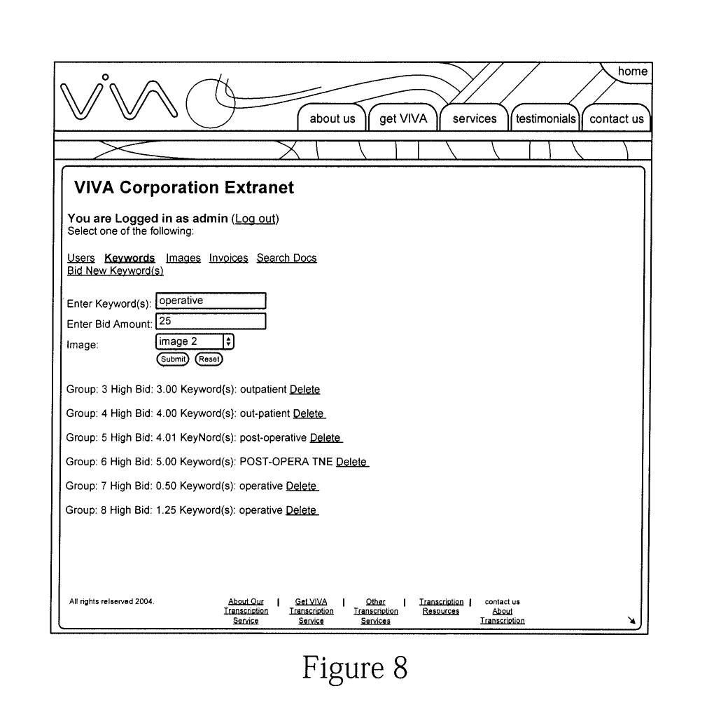

FIG. 6b illustrates an embodiment where the advertising manager may select and order advertisements to be included in documents where selected keywords are found. This part of the system may be accessed only by system administrators and authorized advertising clients or vendors. In the case of a medical data management system, such clients may be pharmaceutical companies, medical equipment manufacturers, and the like. According to one embodiment, when each client accesses the system, he may be directed to a screen that has an overview of the keywords they have previously selected, if any (step 193). The user screen of FIG. 8 may allow a client to delete a keyword (194), bid on a new keyword (195), and/or also allow bill payment (196). The user may enter images of advertisements or other content for association with selected keywords (197). In one embodiment, this may be done in an image management subroutine (198) in which the client can add (199), edit (200) or delete (202) images or other content.

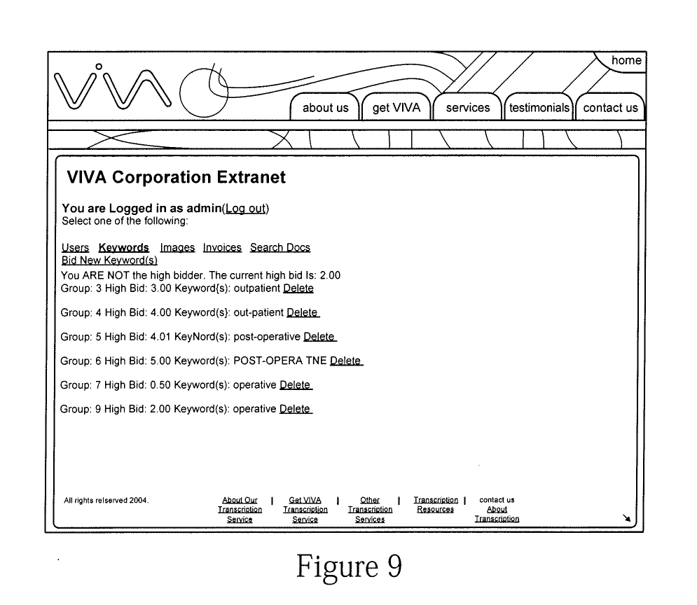

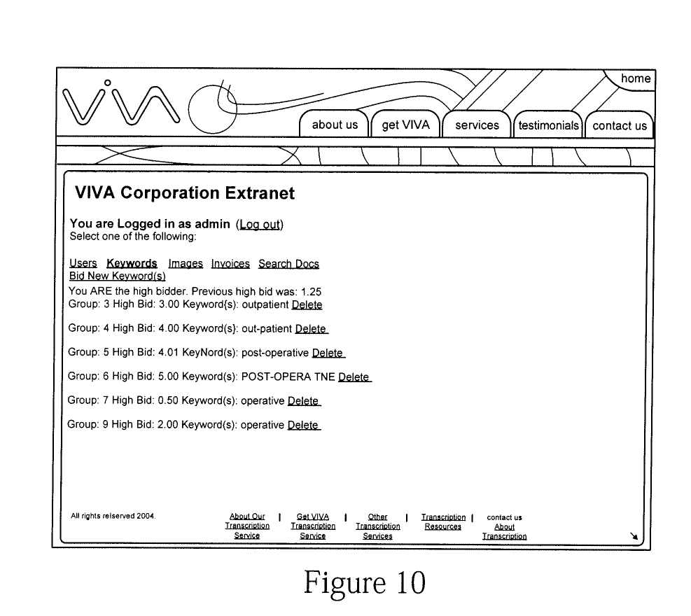

According to one embodiment, the user may enter a keyword to bid on, the associated content, and the bid price (step 204). This is also referenced in 33 of FIG. 2. In FIG. 8, an embodiment is illustrated whereby the user enters the keyword “operative” along with a bid amount of $0.25 for that keyword (step 205). The system determines whether or not the user is the highest bidder for that keyword (step 206). If he is not the highest bidder, he may be returned to the overview screen and informed that he is not the highest bidder for that keyword, as shown in the screen display of FIG. 9. FIG. 9 also illustrates an embodiment where the highest bid for a particular keyword is indicated. In one embodiment, the user may bid again on that keyword or a different keyword. If it is determined that the user is the highest bidder at step 206, a new screen display (FIG. 10) may be generated with the words “You are the high bidder” for that keyword (step 207). One will appreciate that other notification messages may be used to present inform the user or client that he is the highest bidder. An aspect of the present invention may therefore permit a user or client to bid for the option of being a content provider, thus creating a possible revenue generation model for the present invention's content delivery service.

In one embodiment, audio data files found to have one or more active keywords in the insertion manager may have content inserted in order of highest bid price first. Each time the content is inserted or displayed with an audio data file, the client may be billed an amount equal to their bid price. More than one content file may be inserted, in bid order, up to the maximum number of insertions determined by the system administrator. In addition to advertisements, other relevant information and links may be provided in the document, as listed above. The advertising or auction client has the option of bidding for multi-tiered keywords, i.e. placing an advertisement only when two related keywords appear in the document. In one embodiment, the present invention may content based upon constraints set by a user or administrator, such as if the content has already been displayed a certain number or times or if the content provider wishes to alter the marketing strategy.

Although exemplary embodiments of the present invention have been described above by way of example, it will be understood by those skilled in the field that modifications may be made to the disclosed embodiment without departing from the scope of the invention, which is defined by the appended claims. For example, while numerous examples have made reference to the medical transcription context, features of the present invention are equally applicable to other environments and contexts as well. In this manner, aspects of the present invention and its numerous embodiments provide for content delivery from third parties to users based upon information generated from their audio data.

What is claimed is:

1. A method comprising:
receiving audio data;
converting the audio data to a text file representing a transcription of the audio data;
automatically extracting at least one keyword from the content of the text file;
inputting the at least one extracted keyword to a software module; and
associating, by the software module, the at least one extracted keyword with a plurality of content files to identify at least one content file related to the at least one extracted keyword.

2. The method of claim 1, further comprising providing the capability to access the at least one content file identified by the software module.

3. The method of claim 1, further comprising causing delivery of the at least one content file identified by the software module.

4. The method of claim 1, wherein the receiving step, extracting step, associating step and providing step occur in real time.

5. The method of claim 1, wherein the at least one content file comprises one or more files selected from the group consisting of advertisements, text, pertinent keyword-based information, patient-specific information, billing codes, control buttons on a computer screen for ordering selected items or services, control buttons on a computer screen for printing out order forms or prescriptions associated with the document, commands, relevant website links, and links to send information to selected parties.

6. The method of claim 1, further comprising:
if at least two keywords are extracted from the text file, then assigning a numeric value to each keyword;
sorting the keywords by assigned numeric value;
associating a content file with each sorted keyword, each content file matched to each sorted keyword based upon the sort.

7. The method of claim 1, further comprising associating the at least one content file with the at least one keyword by way of an auction, where at least two content file providers bid for the opportunity to associate a specific content file with a specific extracted keyword, and the highest bidding content file provider's content file is associated to the specific extracted keyword.

8. The method of claim 7, wherein the auction is online.

9. The method of claim 1, further comprising:
receiving a second audio data;
converting the second audio data to a second text file representing a transcription of the spoken-word audio data;
automatically extracting at least one keyword from the content of the second text file;
inputting the at least one extracted keyword from the first text file and the at least one extracted keyword from the second text file to a software module; and
associating, by the software module, the at least one extracted keyword from the first text file and the at least one extracted keyword from the second text file with a plurality of content files to identify at least one content file related to the at least one extracted keyword from the first text file and the at least one extracted keyword from the second text file.

10. The method of claim 9, further comprising providing the capability to access the at least one content file identified by the software module.

11. The method of claim 9, further comprising causing delivery of the at least one content file identified by the software module.

12. A method comprising:
receiving audio data;
automatically extracting at least one keyword from the audio data;
inputting the at least one extracted keyword to a software module; and
associating, by the software module, the at least one extracted keyword with a plurality of content files to identify at least one content file related to the at least one extracted keyword.

13. The method of claim 12, further comprising providing the capability to access the at least one content file identified by the software module.

14. The method of claim 12, further comprising causing delivery of the at least one content file identified by the software module.

15. The method of claim 12, wherein the receiving step, extracting step, associating step and providing step occur in real time.

16. The method of claim 12, wherein the at least one content file comprises one or more files selected from the group consisting of advertisements, text, pertinent keyword-based information, patient-specific information, billing codes, control buttons on a computer screen for ordering selected items or services, control buttons on a computer screen for printing out order forms or prescriptions associated with the document, commands, relevant website links, and links to send information to selected parties.

17. The method of claim 12, further comprising:
if at least two keywords are extracted from the text file, then assigning a numeric value to each keyword;
sorting the keywords by assigned numeric value;
associating a content file with each sorted keyword, each content file matched to each sorted keyword based upon the sort.

18. The method of claim 12, further comprising associating the at least one content file with the at least one keyword by way of an auction, where at least two content file providers bid for the opportunity to associate a specific content file with a specific extracted keyword, and the highest bidding content file provider's content file is associated to the specific extracted keyword.

19. The method of claim 12, wherein the auction is online.

20. The method of claim 12, further comprising:
receiving a second audio data;
automatically extracting at least one keyword from the audio data;
inputting the at least one extracted keyword from the first text file and the at least one extracted keyword from the second text file to a software module; and
associating, by the software module, the at least one extracted keyword from the first text file and the at least one extracted keyword from the second text file with a plurality of content files to identify at least one content file related to the at least one extracted keyword from the first text file and the at least one extracted keyword from the second text file.

21. The method of claim 20, further comprising providing the capability to access the at least one content file identified by the software module.

22. The method of claim 20, further comprising causing delivery of the at least one content file identified by the software module.

23. A system comprising:
a computer capable of receiving at least one audio data file;
a database for storing a list of at least one keyword;
a database for storing at least one content file related to a keyword in the stored list;
a first software module with computer readable instructions for reviewing audio data to identify from the audio data at least one keyword from the stored list;
a second software module with computer readable instructions for producing a content file related to the identified keyword from the stored list;
a third software module with computer readable instructions for providing the capability to access the content file identified by the second software.

24. The system of claim 23, wherein the at least one content file comprises one or more files selected from the group consisting of advertisements, text, pertinent keyword-based information, patient-specific information, billing codes, control buttons on a computer screen for ordering selected items or services, control buttons on a computer screen for printing out order forms or prescriptions associated with the document, commands, relevant website links, and links to send information to selected parties.

25. The system of claim 23, further comprising:
an auction manager module for allowing content file providers to enter content files into the system and to bid on keywords to be associated with the entered advertisements, and determining the highest vendor bid for each keyword;
a fourth software module with computer readable instructions for sorting content files associated with keywords matched within the spoken-word audio data, the sorting sorted by auction value with the highest bidder listed first; and
a fifth software module with computer readable instructions for displaying a predetermined number of content files into a displayed spoken-word audio file having associated keywords with the highest bid advertisement inserted first.
